(19) United States
(12) Patent Application Publication
(10) Pub. No.: US 2022/0326691 A1
(43) Pub. Date: Oct. 13, 2022

(54) ROLL-TO-ROLL MACHINING CONTROL DECISION GENERATION METHOD AND APPARATUS FOR FLEXIBLE MATERIAL

(71) Applicant: GUANGDONG UNIVERSITY OF TECHNOLOGY, Guangzhou (CN)

(72) Inventors: Yaohua DENG, Guangzhou (CN); Weijie LI, Guangzhou (CN); Qiwen LU, Guangzhou (CN)

(21) Appl. No.: 17/851,198

(22) Filed: Jun. 28, 2022

Related U.S. Application Data
(63) Continuation of application No. PCT/CN2020/137948, filed on Dec. 21, 2020.

(30) Foreign Application Priority Data
Dec. 15, 2020 (CN) 202011473720.1

(51) Int. Cl. G05B 19/418

(52) U.S. Cl. CPC G05B 19/4183; G05B 19/4184; G05B 19/41815

(57) ABSTRACT

Disclosed are a roll-to-roll machining control decision generation method and apparatus for a flexible material. The method comprises: acquiring first vibration data of a first unwinding module, second vibration data of a second unwinding module, third vibration data of a pressing module, fourth vibration data of a winding module, and rotating speed data and winding tension data of the winding module; calculating to obtain a plurality of health state level combinations according to preset health state levels, the first vibration data, the second vibration data, the third vibration data and the fourth vibration data; generating a winding module rotating speed interval and a winding tension value interval of each health state level combination based on the rotating speed data and the winding tension data; and generating an adjustment decision by using the plurality of health state level combinations, the winding module rotating speed interval and the winding tension value interval.

### CROSS-REFERENCE TO RELATED APPLICATIONS

This application is a continuation of International Patent Application No. PCT/CN2020/137948 with a filing date of Dec. 21, 2021, designating the United States, now pending, and further claims priority to Chinese Patent Application No. 202011473720.1 with a filing date of Dec. 15, 2020. The content of the aforementioned applications, including any intervening amendments thereto, are incorporated herein by reference.

### TECHNICAL FIELD

The present invention relates to the field of data processing technologies, and more particularly, to a roll-to-roll machining control decision generation method and apparatus for a flexible material.

### BACKGROUND

A flexible material has the advantages of low thickness, light weight, scalability, winding capability and durability, and is widely applied in the manufacturing of a flexible printed circuit board, a printed film and a lithium battery cell.

In existing roll-to-roll machining of the flexible material, there are multiple material types, different characteristics and complex deformation influence factors, and it is difficult to control a roll-to-roll machining process. How to establish a relationship between factors affecting a machining quality and solutions of roll-to-roll machining control decision become a difficulty and an industry problem be solved urgently.

### SUMMARY

The present invention provides a roll-to-roll machining control decision generation method and apparatus for a flexible material used for solving technical problems of multiple material types, different characteristics, complex deformation influence factors and difficult roll-to-roll machining process control in existing roll-to-roll machining of the flexible material.

A roll-to-roll machining control decision generation method for a flexible material provided by the present invention is applied in a roll-to-roll machining device for the flexible material, wherein the roll-to-roll machining device for the flexible material comprises a first unwinding module, a second unwinding module, a winding module and a pressing module; and the method comprises:

acquiring first vibration data of the first unwinding module, second vibration data of the second unwinding module, third vibration data of the pressing module, fourth vibration data of the winding module, and rotating speed data and winding tension data of the winding module;

calculating to obtain a plurality of health state level combinations according to preset health state levels, the first vibration data, the second vibration data, the third vibration data and the fourth vibration data;

generating a winding module rotating speed interval and a winding tension value interval of each health state level combination based on the rotating speed data and the winding tension data; and

generating an adjustment decision by using the plurality of health state level combinations, the winding module rotating speed interval and the winding tension value interval.

Optionally, the step of calculating to obtain the plurality of health state level combinations according to the preset health state levels, the first vibration data, the second vibration data, the third vibration data and the fourth vibration data, comprises:

clustering the first vibration data according to the preset health state levels to obtain a plurality of first vibration data sets;

clustering the second vibration data according to the preset health state levels to obtain a plurality of second vibration data sets;

clustering the third vibration data according to the preset health state levels to obtain a plurality of third vibration data sets;

clustering the fourth vibration data according to the preset health state levels to obtain a plurality of fourth vibration data sets; and

combining the first vibration data sets, the second vibration data sets, the third vibration data sets and the fourth vibration data sets according to the preset health state levels to obtain the plurality of health state level combinations;

Optionally, the step of generating the winding module rotating speed interval and the winding tension value interval of each health state level combination based on the rotating speed data and the winding tension data, comprises:

retrieving a data intersection of the first vibration data set, the second vibration data set, the third vibration data set and the fourth vibration data set under each health state level combination;

acquiring a rotating speed data cluster and a winding tension data cluster corresponding to each health state level combination based on the data intersection, the rotating speed data and the winding tension data; and

generating the corresponding winding module rotating speed interval and winding tension value interval of the health state level combination according to the rotating speed data cluster and the winding tension data cluster.

Optionally, the step of generating the corresponding winding module rotating speed interval and winding tension value interval of the health state level combination according to the rotating speed data cluster and the winding tension data cluster, comprises:

calculating a rotating speed arithmetic mean value of the rotating speed data cluster and a tension arithmetic mean value of the tension data cluster;

calculating a standard rotating speed error value of the rotating speed data cluster and a standard tension error value of the tension data cluster;

calculating to obtain the winding module rotating speed interval by using the rotating speed arithmetic mean value and the standard rotating speed error value; and

calculating to obtain the winding tension value interval by using the tension arithmetic mean value and the standard tension error value.

Optionally, the method further comprises:

when abnormal data is monitored in the roll-to-roll machining process of the flexible material, acquiring a target health state level of an abnormal module corresponding to the abnormal data, wherein the abnormal module is one or more of the first unwinding module, the second unwinding module, the pressing module and the winding module;

determining a target winding module rotating speed interval and a target winding tension value interval of the abnormal module according to the target health state level and the adjustment decision; and

adjusting a winding module rotating speed according to the target winding module rotating speed interval, and adjusting a winding tension according to the target winding tension value interval.

The present invention further provides a roll-to-roll machining control decision generation apparatus for a flexible material, comprising:

a data processing module configured for acquiring first vibration data of a first unwinding module, second vibration data of a second unwinding module, third vibration data of a pressing module, fourth vibration data of a winding module, and rotating speed data and winding tension data of the winding module;

a health state level combination division module configured for calculating to obtain a plurality of health state level combinations according to preset health state levels, the first vibration data, the second vibration data, the third vibration data and the fourth vibration data;

an interval generation module configured for generating a winding module rotating speed interval and a winding tension value interval of each health state level combination based on the rotating speed data and the winding tension data; and

an adjustment decision generation module configured for generating an adjustment decision by using the plurality of health state level combinations, the winding module rotating speed interval and the winding tension value interval.

Optionally, the health state level combination division module comprises:

a first vibration data set generation sub-module configured for clustering the first vibration data according to the preset health state levels to obtain a plurality of first vibration data sets;

a second vibration data set generation sub-module configured for clustering the second vibration data according to the preset health state levels to obtain a plurality of second vibration data sets;

a third vibration data set generation sub-module configured for clustering the third vibration data according to the preset health state levels to obtain a plurality of third vibration data sets;

a fourth vibration data set generation sub-module configured for clustering the fourth vibration data according to the preset health state levels to obtain a plurality of fourth vibration data sets; and

a health state level combination division sub-module configured for combining the first vibration data sets, the second vibration data sets, the third vibration data sets and the fourth vibration data sets according to the preset health state levels to obtain the plurality of health state level combinations.

Optionally, the interval generation module comprises:

a data intersection retrieval sub-module configured for retrieving a data intersection of the first vibration data set, the second vibration data set, the third vibration data set and the fourth vibration data set under each health state level combination;

a rotating speed data cluster and winding tension data cluster acquisition sub-module configured for acquiring a rotating speed data cluster and a winding tension data cluster corresponding to each health state level combination based on the data intersection, the rotating speed data and the winding tension data; and

an interval generation sub-module configured for generating the corresponding winding module rotating speed interval and winding tension value interval of the health state level combination according to the rotating speed data cluster and the winding tension data cluster.

The present invention further provides an electronic device, wherein the device comprises a processor and a memory:

the memory is used for storing a program code and transmitting the program code to the processor; and

the processor is used for executing any one of the roll-to-roll machining control decision generation method for the flexible material above according to an instruction in the program code.

The present invention further provides a computer-readable storage medium, wherein the computer-readable storage medium is used for storing a program code, and the program code is used for executing any one of the roll-to-roll machining control decision generation method for the flexible material above.

It can be seen from the technical solutions above that the present invention has the following advantages: in the present invention, the first vibration data of the first unwinding module, the second vibration data of the second unwinding module, the third vibration data of the pressing module, the fourth vibration data of the winding module, and the rotating speed data and the winding tension data of the winding module are acquired; the calculation is performed to obtain the plurality of health state level combinations according to the preset health state levels, the first vibration data, the second vibration data, the third vibration data and the fourth vibration data; the winding module rotating speed interval and the winding tension value interval of each health state level combination are generated based on the rotating speed data and the winding tension data; and the adjustment decision is generated by using the health state levels, the winding module rotating speed interval and the winding tension value interval. Therefore, the roll-to-roll machining process is adjusted based on the adjustment decision, thus solving technical problems of multiple material types, different characteristics, complex deformation influence factors and difficult roll-to-roll machining process control in existing roll-to-roll machining of the flexible material.

### BRIEF DESCRIPTION OF THE DRAWINGS

In order to illustrate the technical solutions in the embodiments of the present invention or in the prior art more clearly, the drawings used in the descriptions of the embodiments or the prior art will be briefly described below. Obviously, the drawings in the following descriptions are merely some embodiments of the present invention. For those of ordinary skills in the art, other drawings may also be obtained based on these drawings without going through any creative work.

FIG. 1 is a schematic diagram of a roll-to-roll machining device for a flexible material provided by an embodiment of the present invention;

FIG. 2 is a flow chart of steps of a roll-to-roll machining control decision generation method for a flexible material provided by an embodiment of the present invention;

FIG. 3 is a flow chart of steps of a roll-to-roll machining control decision generation method for a flexible material provided by another embodiment of the present invention; and

FIG. 4 is a structural block diagram of a roll-to-roll machining control decision generation apparatus for a flexible material provided by an embodiment of the present invention.

### DETAILED DESCRIPTION

An embodiment of the present invention provides a roll-to-roll machining control decision generation method and apparatus for a flexible material used for solving technical problems of multiple material types, different characteristics, complex deformation influence factors and difficult roll-to-roll machining process control in existing roll-to-roll machining of the flexible material.

In order to make the objects, features and advantages of the present invention more obvious and easier to understand, the technical solutions in the embodiments of the present invention are clearly and completely described hereinafter with reference to the drawings in the embodiments of the present invention. Obviously, the embodiments described hereinafter are only some but not all of the embodiments of the present invention. Based on the embodiments in the present invention, all other embodiments obtained by those of ordinary skills in the art without going through any creative work should fall within the scope of protection of the present invention.

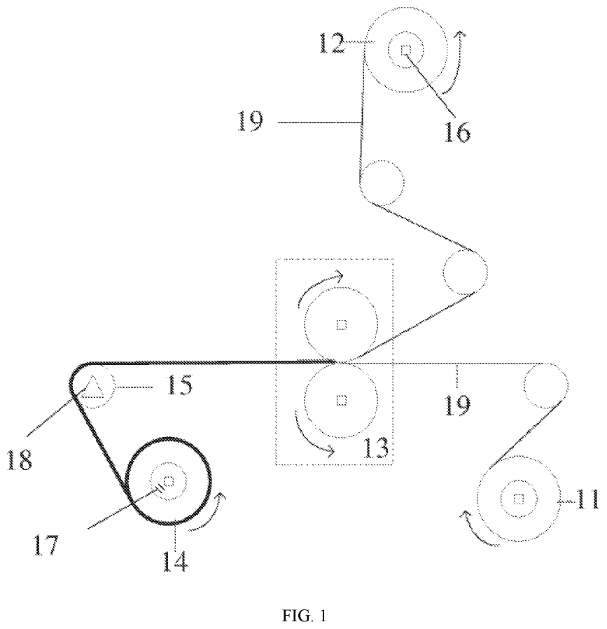

With reference to FIG. 1, FIG. 1 is a schematic diagram of a roll-to-roll machining device for a flexible material provided by an embodiment of the present invention.

As shown in FIG. 1, the roll-to-roll machining device for the flexible material provided by the embodiment of the present invention comprises: a first unwinding module 11, a second unwinding module 12, a pressing module 13, a winding module 14, a transmission module 15, a vibration sensor 16, a speed sensor 17 and a tension sensor 18, and the flexible material 19 is rotated along with rotation of the above modules.

The first unwinding module 11, the second unwinding module 12, the pressing module 13 and the winding module 14 are all provided with the vibration sensor 16 for collecting synchronous vibration data in a machining process of the roll-to-roll machining device for the flexible material. The transmission module 15 is provided with the tension sensor 18 for acquiring a tension value in a winding process. The winding module 14 is also provided with the speed sensor for acquiring a rotating speed of the winding module in the machining process.

Based on the roll-to-roll machining device for the flexible material disclosed in FIG. 1, an embodiment of the present invention provides a roll-to-roll machining control decision generation method for a flexible material used for solving technical problems of multiple material types, different characteristics, complex deformation influence factors and difficult roll-to-roll machining process control in existing roll-to-roll machining of the flexible material.

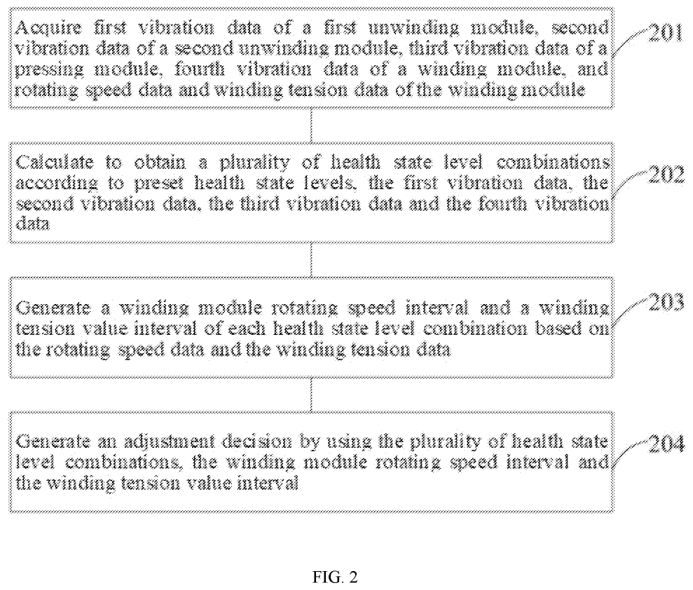

With reference to FIG. 2, FIG. 2 is a flow chart of steps of a roll-to-roll machining control decision generation method for a flexible material provided by an embodiment of the present invention.

The roll-to-roll machining control decision generation method for the flexible material provided by the present invention may specifically comprise the following steps.

In step 201, first vibration data of the first unwinding module, second vibration data of the second unwinding module, third vibration data of the pressing module, fourth vibration data of the winding module, and rotating speed data and winding tension data of the winding module are acquired.

In the embodiment of the present invention, the first unwinding module, the second unwinding module, the pressing module and the winding module are all a roller shaft of the roll-to-roll machining device for the flexible material.

The flexible material refers to a material with certain softness and flexibility. In practical application, the commonly used flexible material is a polymer material, such as resin and fiber. Daily products of the flexible material comprise a clothing fabric and a plastic film. A field of wearable materials involves a flexible electrode and a flexible sensor.

A related roll-to-roll technology refers to a technology of producing a flexible electronic device on a flexible or elastic film by continuous winding. In a highly integrated system, an independent component is mounted on a printed electronic sheet, and then the sheet may be formed by a thermoplastic plastic or a thermoplastic elastomer through an injection molding technology.

In step 202, calculation is performed to obtain a plurality of health state level combinations according to preset health state levels, the first vibration data, the second vibration data, the third vibration data and the fourth vibration data.

In an example of the present invention, four health state levels may be divided, and G={G1, G2, G3, G4} is used for representing four health state levels of each module. G1 represents that a roller shaft module is in an excellent health state with an extremely low damage in roll-to-roll machining of the flexible material. G2 represents that the roller shaft module is in a good health state with a low damage in roll-to-roll machining of the flexible material. G3 represents that the roller shaft module is in a poor health state with a moderate damage in roll-to-roll machining of the flexible material. G4 represents that the roller shaft module is in an extremely poor health state with a severe damage in roll-to-roll machining of the flexible material.

According to the health levels of each module and corresponding vibration data of each module, a plurality of health state level combinations of the first unwinding module, the second unwinding module, the pressing module and the winding module may be obtained.

In step 203, a winding module rotating speed interval and a winding tension value interval of each health state level combination are generated based on the rotating speed data and the winding tension data.

In the embodiment of the present invention, calculation may be performed to obtain the winding module rotating speed interval and the winding tension value interval of each health state level combination according to the rotating speed data and the winding tension data collected under each health state level combination.

In step 204, an adjustment decision is generated by using the plurality of health state level combinations, the winding module rotating speed interval and the winding tension value interval.

In the embodiment of the present invention, after the calculation is performed to obtain the winding module rotating speed interval and the winding tension value interval of each state combination, the adjustment decision may be generated in combination with the health state level combinations, so as to adjust a winding module rotating speed and a winding tension in a roll-to-roll machining process of the flexible material according to the adjustment decision.

In the present invention, the first vibration data of the first unwinding module, the second vibration data of the second unwinding module, the third vibration data of the pressing module, the fourth vibration data of the winding module, and the rotating speed data and the winding tension data of the winding module are acquired; the calculation is performed to obtain the plurality of health state level combinations according to the preset health state levels, the first vibration data, the second vibration data, the third vibration data and the fourth vibration data; the winding module rotating speed interval and the winding tension value interval of each health state level combination are generated based on the rotating speed data and the winding tension data; and the adjustment decision is generated by using the health state levels, the winding module rotating speed interval and the winding tension value interval. Therefore, the roll-to-roll machining process is adjusted based on the adjustment decision, thus solving technical problems of multiple material types, different characteristics, complex deformation influence factors and difficult roll-to-roll machining process control in existing roll-to-roll machining of the flexible material.

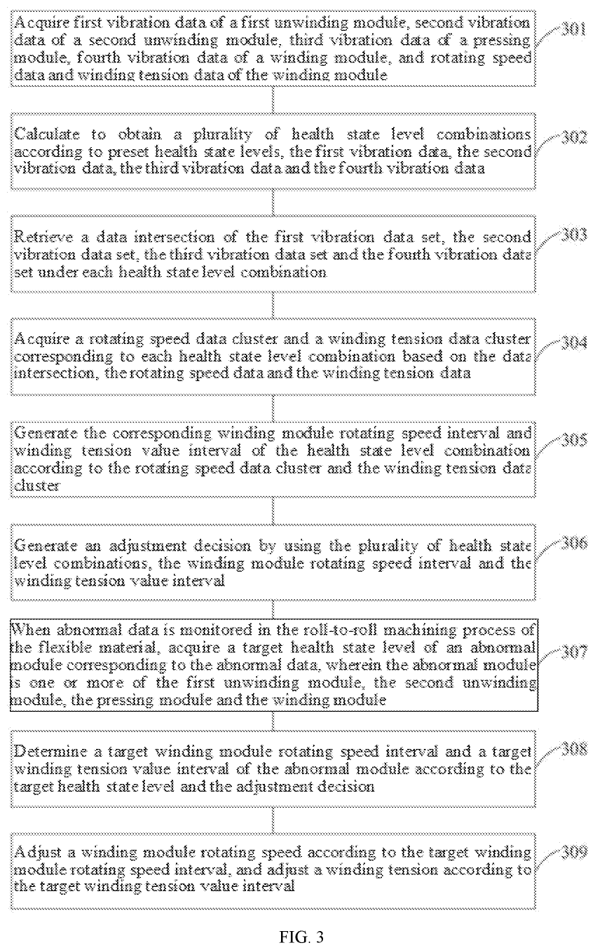

With reference to FIG. 3, FIG. 3 is a flow chart of steps of a roll-to-roll machining control decision generation method for a flexible material provided by another embodiment of the present invention. The method may specifically comprise the following steps.

In step 301, first vibration data of the first unwinding module, second vibration data of the second unwinding module, third vibration data of the pressing module, fourth vibration data of the winding module, and rotating speed data and winding tension data of the winding module are acquired.

In an example, the first vibration data of the first unwinding module may be FJ={f₁, f₂, . . . , fₙ}, the second vibration data of the second unwinding module may be DX={d₁, d₂, . . . , dₙ}, the third vibration data of the pressing module may be YZ={y₁, y₂, . . . , yₙ}, the vibration data of the winding module may be SJ={s₁, s₂, . . . , sₙ}, the rotating speed data of the winding module may be V={v₁, v₂, . . . , vₙ}, and the winding tension data of the winding module may be F={f₁, f₂, . . . , fₙ}, wherein a subscript 1-n represents different moments. Meanwhile, the vibration data of the modules, and the rotating speed data and the winding tension data of the winding module may be represented as (FJᵢ, DXᵢ, YZᵢ, SJᵢ, Vᵢ, Fᵢ), wherein i represents a moment.

In step 302, calculation is performed to obtain a plurality of health state level combinations according to preset health state levels, the first vibration data, the second vibration data, the third vibration data and the fourth vibration data.

In the embodiment of the present invention, step 302 may comprise the following sub-steps of:

clustering the first vibration data according to the preset health state levels to obtain a plurality of first vibration data sets;

clustering the second vibration data according to the preset health state levels to obtain a plurality of second vibration data sets;

clustering the third vibration data according to the preset health state levels to obtain a plurality of third vibration data sets;

clustering the fourth vibration data according to the preset health state levels to obtain a plurality of fourth vibration data sets; and

combining the first vibration data sets, the second vibration data sets, the third vibration data sets and the fourth vibration data sets according to the preset health state levels to obtain the plurality of health state level combinations.

In concrete implementation, the first vibration data FJ of the first unwinding module, the second vibration data DX of the second unwinding module, the third vibration data YZ of the pressing module and the fourth vibration data SJ of the winding module may be divided into four clusters by a fuzzy clustering algorithm according to the four health state levels of the modules, comprising:

the first vibration data set C_{FJ}={C_{FJ}1, C_{FJ2}, C_{FJ3}, C_{FJ4}};

the second vibration data set C_{DX}={C_{DX1}, C_{DX2}, C_{DX3}, C_{DX4}};

the third vibration data set C_{YZ}={C_{YZ1}, C_{YZ2}, C_{YZ3}, C_{YZ4}};

the fourth vibration data set C_{SJ}={C_{SJ1}, C_{SJ2}, C_{SJ3}, C_{SJ4}};

C_{FJi} represents the first vibration data set of the first unwinding module under a Gᵢ health state level, C_{DXi} represents the second vibration data set of the second unwinding module under the Gᵢ health state level, C_{YZi} represents the third vibration data set of the pressing module under the Gᵢ health state level, and C_{SJi} represents the fourth vibration data set of the winding module under the Gᵢ health state level, wherein i=1, 2, 3, 4.

The first unwinding module, the second unwinding module, the pressing module and the winding module respectively have four different health levels, so that the roller shaft module may have 4*4*4*4 (256 in total) health state level combinations Z={Z₁, Z₂, . . . , Z₂₅₆} in the roll-to-roll machining process of the flexible material, and only one state Zᵢ may appear at the same time, wherein i=1, 2, . . . , 256.

In step 303, a data intersection of the first vibration data set, the second vibration data set, the third vibration data set and the fourth vibration data set is retrieved under each health state level combination.

In step 304, a rotating speed data cluster and a winding tension data cluster corresponding to each health state level combination are acquired based on the data intersection, the rotating speed data and the winding tension data.

According to the four clusters of the first unwinding module, the second unwinding module, the pressing module and the winding module, an intersected data set of C_{FJi}, C_{DXi}, C_{YZi} and C_{SJi} under each health state level combination Zᵢ may be retrieved to obtain 256 winding module rotating speed data clusters V_{G}={V_{G1}, V_{G2}, . . . , V_{G256}} and 256 winding tension data clusters F_{G}={F_{G1}, F_{G2}, . . . , F_{G256}} under different health state level combinations Zᵢ.

In step 305, the corresponding winding module rotating speed interval and winding tension value interval of the health state level combination are generated according to the rotating speed data cluster and the winding tension data cluster.

The corresponding winding module rotating speed interval and winding tension value interval of each health state level combination may be generated based on the rotating speed data cluster and the winding tension data cluster.

In an example, step 305 may comprise:

calculating a rotating speed arithmetic mean value of the rotating speed data cluster and a tension arithmetic mean value of the tension data cluster;

calculating a standard rotating speed error value of the rotating speed data cluster and a standard tension error value of the tension data cluster;

calculating to obtain the winding module rotating speed interval by using the rotating speed arithmetic mean value and the standard rotating speed error value; and

calculating to obtain the winding tension value interval by using the tension arithmetic mean value and the standard tension error value.

In concrete implementation, arithmetic mean values M_{V}={M_{V1}, M_{V2}, . . . M_{V256}} and M_{F}={M_{F1}, M_{F2}, . . . , M_{F256}} of 256 winding module rotating speed data clusters and 256 winding tension data clusters are calculated by a mean formula. Standard error values SE_{V}={SE_{V1}, SE_{V2}, . . . , SE_{V256}} and SE_{F}={SE_{F1}, SE_{F2}, . . . , SE_{F256}} of the clusters are calculated by a standard error formula. Then, the winding module rotating speed intervals V_{qi}(i=1, 2, . . . , 256) and the winding tension value intervals F_{qi}(i=1, 2, . . . , 256) under different health state level combinations are calculated by the arithmetic mean values and the standard error values. Mathematical expressions of V_{qi} and F_{qi} are as follows:

$${V}_{qi} = [ {M}_{Vi} - {Z}_{a} \frac{{SE}_{Vi}}{\sqrt{{n}_{i}}} {M}_{Vi} + {Z}_{a} \frac{{SE}_{Vi}}{\sqrt{{n}_{i}}} ] \\ {F}_{qi} = [ {M}_{Fi} - {Z}_{a} \frac{{SE}_{Fi}}{\sqrt{{n}_{i}}} {M}_{Fi} + {Z}_{a} \frac{{SE}_{Fi}}{\sqrt{{n}_{i}}} ]$$

wherein Zₐ is a confidence coefficient, which may be calculated by a confidence level of 95%, and at the moment, a value of Zₐ is 1.96.

In step 306, an adjustment decision is generated by using the plurality of health state level combinations, the winding module rotating speed interval and the winding tension value interval.

After the winding module rotating speed interval and the winding tension value interval of each health state level combination are acquired, the health state levels of the first unwinding module, the second unwinding module, the pressing module and the winding module may be used as conditional attributes, and the winding module rotating speed interval and the winding tension value interval may be used as control rules to establish the adjustment decision of a control solution of the roll-to-roll machining device for the flexible material. Moreover, an adjustment decision table is further generated.

Specifically, the adjustment decision table is shown in Table 1:

TABLE 1

| | | Health | Health | Winding | |
|---|---|---|---|---|---|
| | | state | state | module | Winding |
| First | Second | level of | level of | rotating | tension |
| unwinding | unwinding | pressing | winding | speed | value |
| module | module | module | module | interval | interval |
| G₁ | G₁ | G₁ | G₁ | V_{q1} | F_{q1} |
| G₁ | G₁ | G₁ | G₁ | V_{q2} | F_{q2} |
| . . . | . . . | . . . | . . . | . . . | . . . |
| G₂ | G₁ | G₁ | G₁ | V_{q64} | F_{q64} |
| . . . | . . . | . . . | . . . | . . . | . . . |
| G₄ | G₄ | G₄ | G₄ | V_{q256} | F_{q256} |

In step 307, when abnormal data is monitored in the roll-to-roll machining process of the flexible material, a target health state level of an abnormal module corresponding to the abnormal data is acquired, wherein the abnormal module is one or more of the first unwinding module, the second unwinding module, the pressing module and the winding module.

In step 308, a target winding module rotating speed interval and a target winding tension value interval of the abnormal module are determined according to the target health state level and the adjustment decision.

In step 309, a winding module rotating speed is adjusted according to the target winding module rotating speed interval, and a winding tension is adjusted according to the target winding tension value interval.

In concrete implementation, when one or more abnormal data in the first unwinding module, the second unwinding module, the pressing module and the winding module are monitored in the roll-to-roll machining process of the flexible material, the health state levels of the modules are evaluated at the moment. According to the established adjustment decision, the matching winding module rotating speed interval and winding tension value interval are selected, and the winding module rotating speed and the winding tension at the moment are adjusted to be within the intervals.

In the present invention, the first vibration data of the first unwinding module, the second vibration data of the second unwinding module, the third vibration data of the pressing module, the fourth vibration data of the winding module, and the rotating speed data and the winding tension data of the winding module are acquired; the calculation is performed to obtain the plurality of health state level combinations according to the preset health state levels, the first vibration data, the second vibration data, the third vibration data and the fourth vibration data; the winding module rotating speed interval and the winding tension value interval of each health state level combination are generated based on the rotating speed data and the winding tension data; and the adjustment decision is generated by using the health state levels, the winding module rotating speed interval and the winding tension value interval. Therefore, the roll-to-roll machining process is adjusted based on the adjustment decision, thus solving technical problems of multiple material types, different characteristics, complex deformation influence factors and difficult roll-to-roll machining process control in existing roll-to-roll machining of the flexible material.

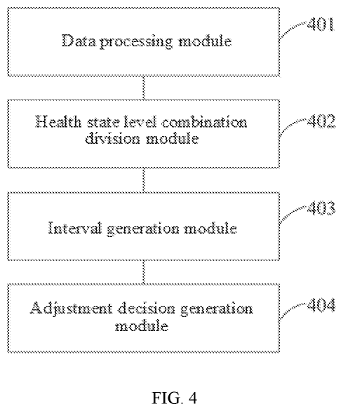

With reference to FIG. 4, FIG. 4 is a structural block diagram of a roll-to-roll machining control decision generation apparatus for a flexible material provided by an embodiment of the present invention.

An embodiment of the present invention provides a roll-to-roll machining control decision generation apparatus for a flexible material, comprising:

a data processing module 401 configured for acquiring first vibration data of a first unwinding module, second vibration data of a second unwinding module, third vibration data of a pressing module, fourth vibration data of a winding module, and rotating speed data and winding tension data of the winding module;

a health state level combination division module 402 configured for calculating to obtain a plurality of health state level combinations according to preset health state levels, the first vibration data, the second vibration data, the third vibration data and the fourth vibration data;

an interval generation module 403 configured for generating a winding module rotating speed interval and a winding tension value interval of each health state level combination based on the rotating speed data and the winding tension data; and

an adjustment decision generation module 404 configured for generating an adjustment decision by using the plurality of health state level combinations, the winding module rotating speed interval and the winding tension value interval.

In the embodiment of the present invention, the health state level combination division module 402 comprises:

a first vibration data set generation sub-module configured for clustering the first vibration data according to the preset health state levels to obtain a plurality of first vibration data sets;

a second vibration data set generation sub-module configured for clustering the second vibration data according to the preset health state levels to obtain a plurality of second vibration data sets;

a third vibration data set generation sub-module configured for clustering the third vibration data according to the preset health state levels to obtain a plurality of third vibration data sets;

a fourth vibration data set generation sub-module configured for clustering the fourth vibration data according to the preset health state levels to obtain a plurality of fourth vibration data sets; and

a health state level combination division sub-module configured for combining the first vibration data sets, the second vibration data sets, the third vibration data sets and the fourth vibration data sets according to the preset health state levels to obtain the plurality of health state level combinations.

In the embodiment of the present invention, the interval generation module 403 comprises:

a data intersection retrieval sub-module configured for retrieving a data intersection of the first vibration data set, the second vibration data set, the third vibration data set and the fourth vibration data set under each health state level combination;

a rotating speed data cluster and winding tension data cluster acquisition sub-module configured for acquiring a rotating speed data cluster and a winding tension data cluster corresponding to each health state level combination based on the data intersection, the rotating speed data and the winding tension data; and

an interval generation sub-module configured for generating the corresponding winding module rotating speed interval and winding tension value interval of the health state level combination according to the rotating speed data cluster and the winding tension data cluster.

In the embodiment of the present invention, the interval generation sub-module comprises:

an arithmetic mean value calculation unit configured for calculating a rotating speed arithmetic mean value of the rotating speed data cluster and a tension arithmetic mean value of the tension data cluster;

a standard error value calculation unit configured for calculating a standard rotating speed error value of the rotating speed data cluster and a standard tension error value of the tension data cluster;

a winding module rotating speed interval calculation unit configured for calculating to obtain the winding module rotating speed interval by using the rotating speed arithmetic mean value and the standard rotating speed error value; and

a winding tension value interval calculation unit configured for calculating to obtain the winding tension value interval by using the tension arithmetic mean value and the standard tension error value.

In the embodiment of the present invention, the apparatus further comprises:

a target health state level acquisition module configured for, when abnormal data is monitored in the roll-to-roll machining process of the flexible material, acquiring a target health state level of an abnormal module corresponding to the abnormal data, wherein the abnormal module is one or more of the first unwinding module, the second unwinding module, the pressing module and the winding module;

a target winding module rotating speed interval and target winding tension value interval determination module configured for determining a target winding module rotating speed interval and a target winding tension value interval of the abnormal module according to the target health state level and the adjustment decision; and

an adjustment module configured for adjusting a winding module rotating speed according to the target winding module rotating speed interval, and adjusting a winding tension according to the target winding tension value interval.

An embodiment of the present invention further provides an electronic device, wherein the device comprises a processor and a memory:

the memory is used for storing a program code and transmitting the program code to the processor; and

the processor is used for executing the roll-to-roll machining control decision generation method for the flexible material in the embodiment of the present invention according to an instruction in the program code.

An embodiment of the present invention further provides a computer-readable storage medium, wherein the computer-readable storage medium is used for storing a program code, and the program code is used for executing the roll-to-roll machining control decision generation method for the flexible material in the embodiment of the present invention.

It can be clearly understood by those skilled in the art that, for the sake of convenience and brevity in description, a detailed working process of the foregoing apparatus and unit may refer to a corresponding process in the foregoing method embodiments, and will not be elaborated herein.

Each embodiment in this specification is described in a progressive way, each embodiment focuses on the differences from other embodiments, and the same and similar parts between the embodiments may be referred to each other.

It should be appreciated by those skilled in this art that the embodiments of the present invention may be provided as methods, apparatuses or computer program products. Therefore, the embodiments of the present invention may take the form of complete hardware embodiments, complete software embodiments or software-hardware combined embodiments. Moreover, the embodiments of the present invention may take the form of a computer program product embodied on one or more computer usable storage media (including but not limited to disk storage, CD-ROM, optical storage, etc.) in which computer usable program codes are included.

The embodiments of the present invention are described with reference to the flow charts and/or block diagrams of the method, terminal device (system), and computer program products according to the embodiments of the present invention. It should be appreciated that each flow and/or block in the flow charts and/or block diagrams, and combinations of the flows and/or blocks in the flow charts and/or block diagrams may be implemented by computer program instructions. These computer program instructions may be provided to a general purpose computer, a special purpose computer, an embedded processor, or a processor of other programmable data processing terminal device to produce a machine for the instructions executed by the computer or the processor of other programmable data processing terminal device to generate an apparatus for implementing the functions specified in one or more flows of the flow chart and/or in one or more blocks of the block diagram.

These computer program instructions may also be provided to a computer readable memory that can guide the computer or other programmable data processing terminal device to work in a given manner, so that the instructions stored in the computer readable memory generate a product including an instruction apparatus that implements the functions specified in one or more flows of the flow chart and/or in one or more blocks of the block diagram.

These computer program instructions may also be loaded to a computer, or other programmable terminal device, so that a series of operating steps are executed on the computer, or other programmable terminal device to produce processing implemented by the computer, so that the instructions executed in the computer or other programmable terminal device provide steps for implementing the functions specified in one or more flows of the flow chart and/or in one or more blocks of the block diagram.

Although the preferred embodiments of the present invention have been described, those skilled in the art can make additional changes and modifications to these embodiments once they know the basic inventive concepts. Therefore, the appended claims are intended to be interpreted as including the preferred embodiments and all the changes and modifications that fall within the scope of the embodiments of the present invention.

Finally, it should be also noted that relational terms herein such as first and second, etc., are used merely to distinguish one entity or operation from another entity or operation, and do not necessarily require or imply there is any such relationship or order between these entities or operations. Furthermore, the terms “including”, “comprising” or any variations thereof are intended to embrace a non-exclusive inclusion, such that a process, method, article, or terminal device including a plurality of elements includes not only those elements but also includes other elements not expressly listed, or also includes elements inherent to such a process, method, item, or terminal device. In the absence of further limitation, an element defined by the phrase “including a . . . ” does not exclude the presence of additional identical element in the process, method, article, or terminal device.

As mentioned above, the above embodiments are only used to illustrate the technical solution of the invention, rather than limiting the present invention; although the present invention has been described in detail with reference to the foregoing embodiments, those of ordinary skills in the art should understand that: he can still modify the technical solutions set forth by the above embodiments, or make equivalent substitutions to part of the technical features of them. However, these modifications or substitutions shall not depart from the spirit and scope of the technical solutions of the embodiments of the present invention.

1. A roll-to-roll machining control decision generation method for a flexible material applied in a roll-to-roll machining device for the flexible material, wherein the roll-to-roll machining device for the flexible material comprises a first unwinding module, a second unwinding module, a winding module and a pressing module; and the method comprises:
acquiring first vibration data of the first unwinding module, second vibration data of the second unwinding module, third vibration data of the pressing module, fourth vibration data of the winding module, and rotating speed data and winding tension data of the winding module;
calculating to obtain a plurality of health state level combinations according to preset health state levels, the first vibration data, the second vibration data, the third vibration data and the fourth vibration data;
generating a winding module rotating speed interval and a winding tension value interval of each health state level combination based on the rotating speed data and the winding tension data; and
generating an adjustment decision by using the plurality of health state level combinations, the winding module rotating speed interval and the winding tension value interval.

2. The method according to claim 1, wherein the step of calculating to obtain the plurality of health state level combinations according to the preset health state levels, the first vibration data, the second vibration data, the third vibration data and the fourth vibration data, comprises:
clustering the first vibration data according to the preset health state levels to obtain a plurality of first vibration data sets;
clustering the second vibration data according to the preset health state levels to obtain a plurality of second vibration data sets;
clustering the third vibration data according to the preset health state levels to obtain a plurality of third vibration data sets;
clustering the fourth vibration data according to the preset health state levels to obtain a plurality of fourth vibration data sets; and
combining the first vibration data sets, the second vibration data sets, the third vibration data sets and the fourth vibration data sets according to the preset health state levels to obtain the plurality of health state level combinations.

3. The method according to claim 2, wherein the step of generating the winding module rotating speed interval and the winding tension value interval of each health state level combination based on the rotating speed data and the winding tension data, comprises:
retrieving a data intersection of the first vibration data set, the second vibration data set, the third vibration data set and the fourth vibration data set under each health state level combination;
acquiring a rotating speed data cluster and a winding tension data cluster corresponding to each health state level combination based on the data intersection, the rotating speed data and the winding tension data; and
generating the corresponding winding module rotating speed interval and winding tension value interval of the health state level combination according to the rotating speed data cluster and the winding tension data cluster.

4. The method according to claim 3, wherein the step of generating the corresponding winding module rotating speed interval and winding tension value interval of the health state level combination according to the rotating speed data cluster and the winding tension data cluster, comprises:
calculating a rotating speed arithmetic mean value of the rotating speed data cluster and a tension arithmetic mean value of the tension data cluster;
calculating a standard rotating speed error value of the rotating speed data cluster and a standard tension error value of the tension data cluster;
calculating to obtain the winding module rotating speed interval by using the rotating speed arithmetic mean value and the standard rotating speed error value; and
calculating to obtain the winding tension value interval by using the tension arithmetic mean value and the standard tension error value.

5. The method according to claim 1, further comprising:
when abnormal data is monitored in the roll-to-roll machining process of the flexible material, acquiring a target health state level of an abnormal module corresponding to the abnormal data, wherein the abnormal module is one or more of the first unwinding module, the second unwinding module, the pressing module and the winding module;
determining a target winding module rotating speed interval and a target winding tension value interval of the abnormal module according to the target health state level and the adjustment decision; and
adjusting a winding module rotating speed according to the target winding module rotating speed interval, and adjusting a winding tension according to the target winding tension value interval.

6. A roll-to-roll machining control decision generation apparatus for a flexible material, comprising:
a data processing module configured for acquiring first vibration data of a first unwinding module, second vibration data of a second unwinding module, third vibration data of a pressing module, fourth vibration data of a winding module, and rotating speed data and winding tension data of the winding module;
a health state level combination division module configured for calculating to obtain a plurality of health state level combinations according to preset health state levels, the first vibration data, the second vibration data, the third vibration data and the fourth vibration data;
an interval generation module configured for generating a winding module rotating speed interval and a winding tension value interval of each health state level combination based on the rotating speed data and the winding tension data; and
an adjustment decision generation module configured for generating an adjustment decision by using the plurality of health state level combinations, the winding module rotating speed interval and the winding tension value interval.

7. The apparatus according to claim 6, wherein the health state level combination division module comprises:
a first vibration data set generation sub-module configured for clustering the first vibration data according to the preset health state levels to obtain a plurality of first vibration data sets;
a second vibration data set generation sub-module configured for clustering the second vibration data according to the preset health state levels to obtain a plurality of second vibration data sets;
a third vibration data set generation sub-module configured for clustering the third vibration data according to the preset health state levels to obtain a plurality of third vibration data sets;
a fourth vibration data set generation sub-module configured for clustering the fourth vibration data according to the preset health state levels to obtain a plurality of fourth vibration data sets; and
a health state level combination division sub-module configured for combining the first vibration data sets, the second vibration data sets, the third vibration data sets and the fourth vibration data sets according to the preset health state levels to obtain the plurality of health state level combinations.

8. The apparatus according to claim 7, wherein the interval generation module comprises:
a data intersection retrieval sub-module configured for retrieving a data intersection of the first vibration data set, the second vibration data set, the third vibration data set and the fourth vibration data set under each health state level combination;
a rotating speed data cluster and winding tension data cluster acquisition sub-module configured for acquiring a rotating speed data cluster and a winding tension data cluster corresponding to each health state level combination based on the data intersection, the rotating speed data and the winding tension data; and
an interval generation sub-module configured for generating the corresponding winding module rotating speed interval and winding tension value interval of the health state level combination according to the rotating speed data cluster and the winding tension data cluster.

9. An electronic device, wherein the device comprises a processor and a memory:
the memory is used for storing a program code and transmitting the program code to the processor; and
the processor is used for executing a roll-to-roll machining control decision generation method for a flexible material, wherein the method is applied in a roll-to-roll machining device for the flexible material, and the roll-to-roll machining device for the flexible material comprises a first unwinding module, a second unwinding module, a winding module and a pressing module; and the method comprises:
acquiring first vibration data of the first unwinding module, second vibration data of the second unwinding module, third vibration data of the pressing module, fourth vibration data of the winding module, and rotating speed data and winding tension data of the winding module;
calculating to obtain a plurality of health state level combinations according to preset health state levels, the first vibration data, the second vibration data, the third vibration data and the fourth vibration data;
generating a winding module rotating speed interval and a winding tension value interval of each health state level combination based on the rotating speed data and the winding tension data; and
generating an adjustment decision by using the plurality of health state level combinations, the winding module rotating speed interval and the winding tension value interval.

10. The electronic device according to claim 9, wherein the step of calculating to obtain the plurality of health state level combinations according to the preset health state levels, the first vibration data, the second vibration data, the third vibration data and the fourth vibration data, comprises:
clustering the first vibration data according to the preset health state levels to obtain a plurality of first vibration data sets;
clustering the second vibration data according to the preset health state levels to obtain a plurality of second vibration data sets;
clustering the third vibration data according to the preset health state levels to obtain a plurality of third vibration data sets;
clustering the fourth vibration data according to the preset health state levels to obtain a plurality of fourth vibration data sets; and
combining the first vibration data sets, the second vibration data sets, the third vibration data sets and the fourth vibration data sets according to the preset health state levels to obtain the plurality of health state level combinations.

11. The electronic device according to claim 10, wherein the step of generating the winding module rotating speed interval and the winding tension value interval of each health state level combination based on the rotating speed data and the winding tension data, comprises:
retrieving a data intersection of the first vibration data set, the second vibration data set, the third vibration data set and the fourth vibration data set under each health state level combination;
acquiring a rotating speed data cluster and a winding tension data cluster corresponding to each health state level combination based on the data intersection, the rotating speed data and the winding tension data; and
generating the corresponding winding module rotating speed interval and winding tension value interval of the health state level combination according to the rotating speed data cluster and the winding tension data cluster.

12. The electronic device according to claim 11, wherein the step of generating the corresponding winding module rotating speed interval and winding tension value interval of the health state level combination according to the rotating speed data cluster and the winding tension data cluster, comprises:
calculating a rotating speed arithmetic mean value of the rotating speed data cluster and a tension arithmetic mean value of the tension data cluster;
calculating a standard rotating speed error value of the rotating speed data cluster and a standard tension error value of the tension data cluster;
calculating to obtain the winding module rotating speed interval by using the rotating speed arithmetic mean value and the standard rotating speed error value; and
calculating to obtain the winding tension value interval by using the tension arithmetic mean value and the standard tension error value.

13. The electronic device according to claim 9, further comprising:
when abnormal data is monitored in the roll-to-roll machining process of the flexible material, acquiring a target health state level of an abnormal module corresponding to the abnormal data, wherein the abnormal module is one or more of the first unwinding module, the second unwinding module, the pressing module and the winding module;
determining a target winding module rotating speed interval and a target winding tension value interval of the abnormal module according to the target health state level and the adjustment decision; and
adjusting a winding module rotating speed according to the target winding module rotating speed interval, and adjusting a winding tension according to the target winding tension value interval.
